(19) United States
(12) Patent Application Publication
(10) Pub. No.: US 2017/0053223 A1
(43) Pub. Date: Feb. 23, 2017

(54) Determining Payload Estimate

(71) Applicant: Hewlett-Packard Development Company, L.P., Fort Collins, CO (US)

(72) Inventors: Sunil KOTHARI, Palo Alto, CA (US); Jun ZENG, Palo Alto, CA (US); Gary J DISPOTO, Palo Alto, CA (US)

(21) Appl. No.: 15/307,345

(22) PCT Filed: Apr. 30, 2014
(86) PCT No.: PCT/US2014/036227

§ 371 Date: Oct. 27, 2016

(51) Int. Cl. G06Q 10/06; G06N 3/08

(52) U.S. Cl. CPC G06Q 10/06313; G06N 3/086

(57) ABSTRACT

Determining a payload estimate for a task in a process includes learning a payload control, storing a learned payload control in a database, and evaluating the payload estimate. Learning includes applying machine learning to process information to determine a learned payload control corresponding to the task in the process. Evaluating the payload estimate includes searching the database for a plurality of payload controls relevant to the task including the learned payload control, determining whether a condition of the learned payload control is met, and applying the payload control to determine the payload estimate using process information if the condition of the learned payload control is satisfied.

### BACKGROUND

Various domains such as manufacturing, transportation, healthcare, and others, apply operational and strategic planning to make short term and long-term predictions for an enterprise. The enterprise can use such planning to address anticipated changes in resources, demand, operating procedures, or some combination of expectations. The enterprise can also use such planning to address production scheduling and resource assignments.

### BRIEF DESCRIPTION OF THE DRAWINGS

FIG. 1A is a block diagram illustrating example system for operational and strategic planning.

FIG. 1B is a block diagram illustrating an example system for determining payload estimates in the example system of FIG. 1A.

FIG. 2 is a block diagram illustrating an example process of determining payload estimates as part of the example systems of FIGS. 1A and 1B.

FIG. 3 is a flow diagram illustrating an example process of learning payload controls as part of the example process of FIG. 2.

FIG. 4 is a flow diagram illustrating an example process of computing a payload estimate from payload controls determined in the example of FIG. 3.

FIG. 5 is a block diagram illustrating an example computing device for use with the example systems of FIGS. 1A and 1B to perform the example processes of FIGS. 2-4.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

Operational and strategic planning can involve determining an amount work to be performed to complete a task in a process to produce a good or service. In one example, amount of work can include determining a payload estimate. Determining a payload estimate for a task in a process includes learning a payload control, storing a learned payload control in a database, and evaluating the payload estimate Learning includes applying machine learning to process information to determine a learned payload control corresponding to the task in the process. Evaluating the payload estimate includes searching the database for a plurality of payload controls relevant to the task including the learned payload control, determining whether a condition of the learned payload control is met, and applying the payload control to determine the payload estimate using process information if the condition of the learned payload control is satisfied. Payload estimates determined this way are dynamic and adaptive to changes in the processes to produce goods and services as well as producing reusable payload controls that can be applied in other circumstances.

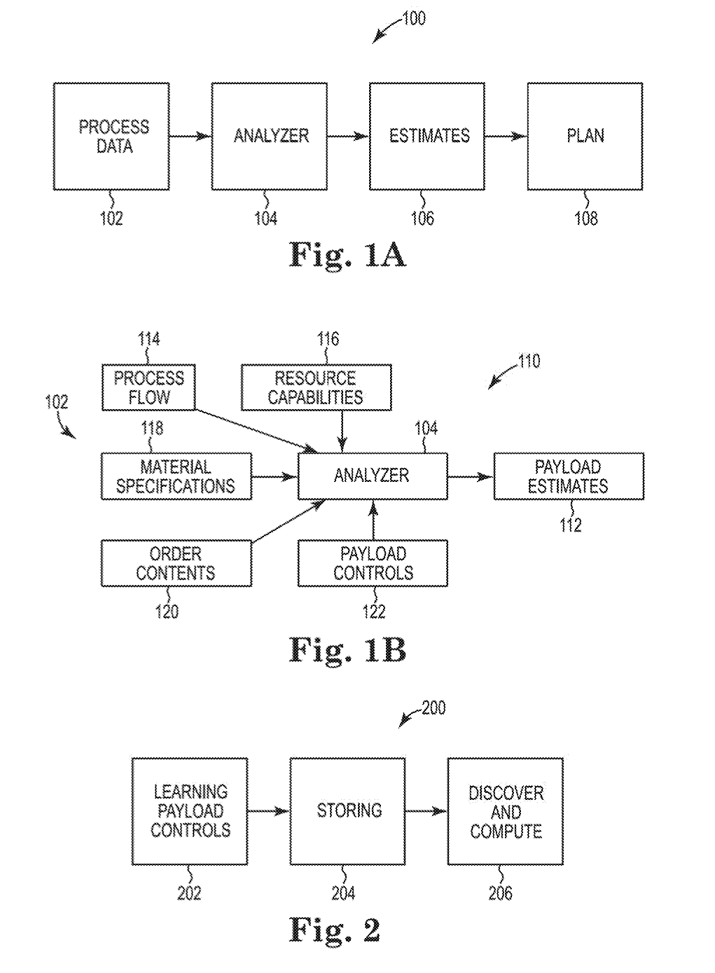

FIG. 1A illustrates an example system 100 for operational and strategic planning. One example of the system 100 can be used with process information 102, such as information developed from a manufacturing process, such as two dimensional printing or three dimensional printing, or other process in a selected domain. The process is used to create a product, which in general can include products and services depending on the domain, that is part of a customers order. In one example, the process includes a set of tasks to be performed. For instance, the product is created from a set of dependent tasks as described in a production plan. In one example, the dependent tasks can be illustrated in a directed acyclic graph, which is commonly abbreviated as DAG. The tasks are represented as nodes and the dependencies are represented as the edges of the DAG. The tasks in the production plan can be assigned to a resource, such as a particular machine. In cases of a process including a re-work procedure, re-entry edges can be appended on the DAG resulting in a directed cyclic graph. Depending on different modes and production situations, a failed job at one process can be routed to different upstream processes for re-work. Other examples are contemplated.

Process information 102 is provided to an analyzer 104, which is tool such as a software tool running on a computing device or computing system. The analyzer 104 applies the process information 102, as well as other information or assumptions, to make determinations about the process. In one example, these determinations can include estimates 106 about future runs of the process 102. These estimates 106 can be applied to create an operational and strategic plan 108.

One example of an estimate 106 often used in operational and strategic planning includes a prediction of an amount of work to be applied to a particular task of the process. A measure of this amount of work for a task is referred to as a payload estimate. In an example of commercial and industrial printing, used here for illustration, the amount of work, as described in a payload estimate, for a given print services provider to complete a trim task of a photobook with batching can increase as the number of copies increases above a minimum payload estimate. If certain parameters are known, the amount of work to complete the project can be determined and resources can be allocated accordingly.

Payload estimates are typically determined off-line and are applicable to a single task for a given machine at a specific time. In the example of commercial and industrial printing, a print service provider manufacturing a photobook for a customer may assign a payload estimate to a task such as raster image processing. The assigned payload estimate, for instance “40” in this illustration, is static and inconsistent if it were assigned into the plan 108. The payload estimate is static because it does not change or evolve with changes, such as changes in procedures, operating policies, and skill or efficiencies of the workers, over time. The payload estimate is inconsistent because raster image processing is more difficult or time consuming at different resolutions or for different sizes of an image. Such payload estimates often do not produce meaningful results in planning.

Determining a meaningful payload estimate is challenging. For example, a payload estimate can be dependent on a particular combination of a product, task, and resource used to perform the task. In the illustration of commercial and industrial printing, a payload estimate for trimming, or a trim task, for a photobook might be different than a trim task for a poster. Also a payload estimate for a trim task for a photobook using a first trimming machine may be different than a payload estimate for second trimming machine for the photobook. Payload estimates are dependent on production history, such as the content of a recently completed process, and set up times can differ. For example, trimming books of different thicknesses affects how the payload estimate is determined. Also, payload estimates can become obsolete quickly as processes become more efficient or changes occur in policies. Still further, each product can be different, such as in mass customizations, and static approaches do not scale well in such circumstances.

FIG. 1B illustrates a system 110 for determining payload estimates 112, using the analyzer 104. The system 110 and other parts of the disclosure are provided in the context of printing services, or print service providers for illustration only. The illustrated concepts and techniques can be applied to strategic and operational planning in other domains.

As illustrated above, process information 102 is provided to the analyzer 104. In FIG. 1B, process information 102 can include items such as a process flow 114 for a given product, such as a photobook. The process flow 114 in the example is in the form of a DAG or other directed graph. Other process information 102 can include resource capabilities 116, such as equipment capabilities. In one example, the resource capabilities 116 can include different features or specifications for the machines used to perform the tasks in the process flow 114. In one example, the resource capabilities can include specifications for a trimmer such as capacity, throughput, maximum lengths and widths. Other items of process information 102 can include material specifications 118 and order contents 120. Material specifications can include information such as weights, thicknesses, coatings of the substrates used, and type of ink. The order contents 120 can include specifications on the type of products, such as the type of cover, the number of pages, the size of the pages, and the print resolution. Process information 102 can also include information from production logs such as length of time for a task to enter a queue in a machine, start time of the task, end time of the task, and the like. The process information 102 can be stored in a database or databases and accessed from production logs and management information services (MIS)/enterprise resource planning (ERP) tools.

The analyzer 104 applies a set of payload control 122 to the process information 102 to determine the payload estimates 112. A payload control in one example is associated with a task to resolve a payload estimate for the task such as a task included in process flow 114. In one example, a payload control is an expression in the form of “A=>B”. A is a guard and includes a condition, and B is a computation that resolves the payload estimate for the task if the condition is met. In one example, A is a Boolean expression, or Boolean trigger, which evaluates as either true or false, and serves as a guard for computation B of the payload control. The computation evaluates to a number, such as a decimal number. The semantics of this example syntax is if A is true then computation B is performed.

This formalism is expressive enough to encode an entire decision tree as a collection of payload controls such that a member of the set of payload control 122 represents each path in the decision tree. In one example, a set of payload controls can encapsulate an entire decision tree. In another example, however, a set of payload controls can include one or more rules in circumstances where choices are not deterministically decided or where choices are to be weighed against each other due to incomplete information, for example, as in fuzzy logic. Other configurations are contemplated

Both the guard and the computation can contain order attributes and machine capability attributes inside the payload control. In one example, the process information 102 can provide attributes including number of pages, number of copies, sheet size, image coverage, and machine capacity. The payload control can contain functions selected from a rich math library of a database for consistency. For example, math operators in a relational database management system, such as the open source implementation MySQL, can include ABS( ) to return an absolute value, ACOS( ) to return an arc cosine, etc.

A first example of a payload control to determine a payload estimate for a trim task in a photobook with batching can be:

copy>=200=>ceil(page/max_capacity)*3

copy<200=>3

In this example, the guard is based on a threshold number of copies to be cut. If the number of copies is equal to or above the threshold, an expression is used to determine the ceiling, or smallest following integer, or an operation of certain parameters of the project multiplied by a constant. In this example, the ceil( ) is at least one and the constant is three so the payload estimate is at least three. If, however, the number of copies is below the threshold, the payload estimate is a set number such as three.

A second example payload control to determine a payload estimate for a trim task in a poster can be:

True=>max(ceil(copy/(batch_size*max_capacity)), 1)

In this example, a payload estimate for a trim task in a poster will be based on a formula using various parameters of the project but will not be less than one. Depending on the parameters used, the payload estimate of a trim task for a poster according to the second example can be more or less than the trim task for a photobook according to the first example.

Accordingly, payload control can be specified for each product and for each process used in that product. One difficulty of using payload controls in this manner, however, includes maintaining and updating the controls as features and policies change, sometimes without notice such as in mass customization. For a print service provider that produces, for example, ten products and includes at least twenty tasks for each product, the print service provider would attempt to maintain and update at least two hundred payload controls.

FIG. 2 illustrates an example process 200 to maintain and update payload controls 102 to determine payload estimates. Default payload controls are developed, or improved, to better reflect variations that can occur during actual production, i.e., the process learns Payload controls at 202 from the process information 102. Learned controls are stored in a database at 204 in a manner to allow for efficient querying. A task can have multiple associated expressions as different paths in a decision tree, and process 200 provides a systematic way to discover and compute the relevant controls for the particular task at 206.

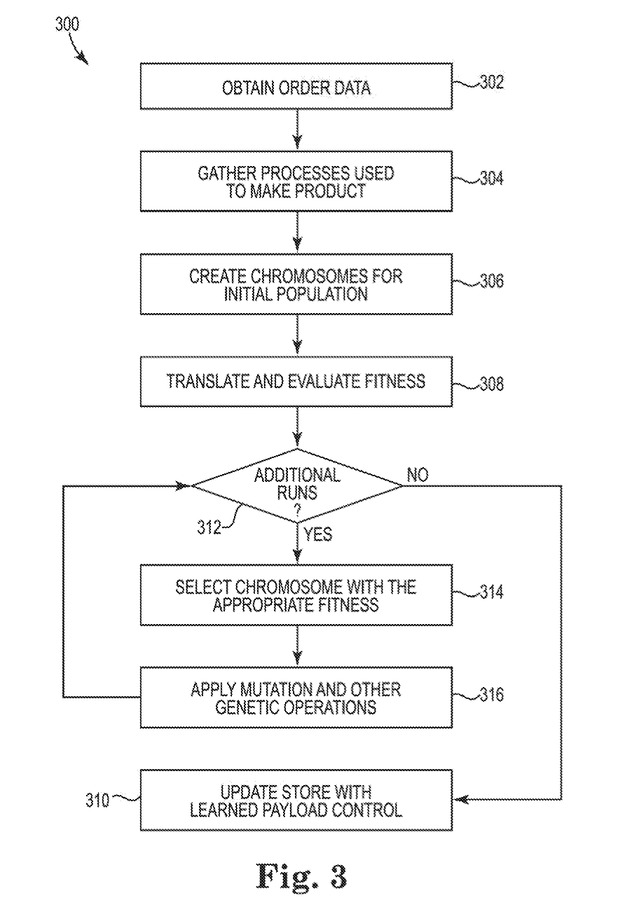

FIG. 3 illustrates an example process 300 that can be used in learning or refining payload controls 202 from the process information 102 such as from an MIS/ERP system. The payload estimates are thus tailored to have fidelity with production audit data. In the case of a new product or process, i.e., one not having enough data to refine a payload control, a default payload control is assigned and used. In one example, a default payload control can be based on a general payload control from a similar or analogous process category. In the example of a print service provider, a finite set of process categories can be determined to describe the entire set of production processes in the factory. In one example, the functions of a print factory can be generalized into approximately five or six categories such as image processing, printing, cutting, assembly, packaging, or other categories. One such category can include the trim process. A trim process in a photobook can have similar attributes as a trim process for a poster, such as number of pages, print capacity, etc. The individual products can be used to specialize the general payload control from the processes category to create the default expression. As more data, such as process information 102, becomes available, the default payload control is refined to accurately produce the actual payload estimate. Using such meta-information from the process categories can eliminate irrelevant or marginal attributes from the payload expressions that traditionally can make machine learning difficult.

In the example process 300, machine learning, or artificial intelligence, is applied to the process information 102. The example process 300 applies an evolutionary algorithm to create or learn payload control models. In the example process 300, the evolutionary algorithm is Genetic Expression Programming. Other processes for learning payload control 202 form the process information 102 can be determined from other evolutionary algorithms, a neural network type program such as Multilayer Perceptron, the C4.5 algorithm and its successors to generate a decision tree, and other artificial intelligence or clustering, regression, and classification algorithms. A symbolic control such as one learned from Genetic Expression Programming or the C4.5 algorithm (or a successor), for example, can be compared to other learned controls to see which control has a more efficient task.

In general, Genetic Expression Programming is a genotype/phenotype system that evolves computer programs encoded in chromosomes. The chromosomes can be of fixed or variable length, and, in one example, chromosomes can be linear although other examples are contemplated. The organization of the chromosomes allows the unconstrained and effective, in the sense that no invalid phenotypes will follow, functions of genetic operators such as mutation, transposition, and recombination as the expression of each gene results in valid programs. The genotype/phenotype system of Gene Expression Programming includes a translation mechanism. Genotypes are conveyed as chromosomes, and phenotypes are conveyed as expression trees. Genetic Expression Programming shares the same kind of tree representation as other genetic programming, such as Genetic Algorithms and Genetic Programming. Genetic Expression Programming makes possible the ability to retrace the steps undertaken through genetic programming and to explore new issues created with crossing of the phenotype threshold.

Process 300 includes obtaining order data and terminals from the MIS/ERP system and other audit data from production logs at 302. Examples of terminals in the first example payload estimate above include “batch_size” and “copy” and a control database or math library provides functions such as “ceil” and “max” and other terminals if applicable such as π (pi). The processes used to make the product are gathered at 304. The controls are learned as individual genes of a chromosome, and chromosomes are created for initial population at 306. In connection with feature 306, a database engine can be selected to evaluate the genes and to provide non-terminals and arity, or number of arguments or operands in the payload control, for Genetic Expression Programming. Gene Expression Programming can encode multiple genes in a chromosome and can reduce the iterations used to achieve accurate expressions. Guards can be learned separately or together with the computations with the help of operators. Each chromosome is translated into a control and its fitness is evaluated at 308. In one example, the fitness of is evaluated by comparing the processing times for the task, as determined from the process information 102 against the result of the payload estimate and the unit processing times, for that task, from the MIS/ERP system. The updated payload expressions are then stored at 310 such as in an expression store.

As additional process information 102 becomes available at 312, such an in the case of additional runs of the task, at 312, the payload controls can be further refined. With the additional process information 102, process 300 updates or selects the chromosomes having the appropriate fitness at 314. Mutation and other genetic operations used in the evolutionary algorithm are applied at 316, and the chromosomes are translated and its fitness is evaluated at 308.

The payload controls 112 are stored in a database 204 in a string format as well-formed expressions in an efficient manner to be processed quickly. In one example, payload controls can be indexed, such as with a hash function, for quick retrieval. This is helpful for both production planning and strategic planning applications, and each application can now decouple its payload calculation from the rest of the application, in one example, the guard and the computation are stored separately, which makes for a more efficient query. In one example, attributes are appended with an “@” to support global variables instead of the mathematical functions and contents defined in a special purpose programming language, such as Structured Language Query (or SQL), designed to work with the relational database management system. For example, a guard stored as a string in a database may appear as:

@paperQuality==‘20 gsm’&&@pages<200

A computation stored as a string in a database may appear as:

ceil(@pages/@max_capacity)*3

Capability attributes can be made specific to a resource group. A resource group is a collection of resources that having members that share common attributes. For example, resource group may include trimming machines from various venders and from various models within the same vendor. The resource group may be named “trimmers,” for example, and may be characterized by common attributes such as width, height, trimming length behind the knife, and the like. An attribute in the payload expressions can be made specific to a resource group. Thus, if a payload control includes the attribute “height,” for example, the actual value of that height can be determined along with the corresponding resource group, even if the specific resource to perform the task is not known.

The payload controls are retrieved from the database to compute the payload estimates such as at 206. In one example, a parser, such as an SQL parser, to help calculate the payload estimates. An SQL engine access the math library functions for efficient implementation.

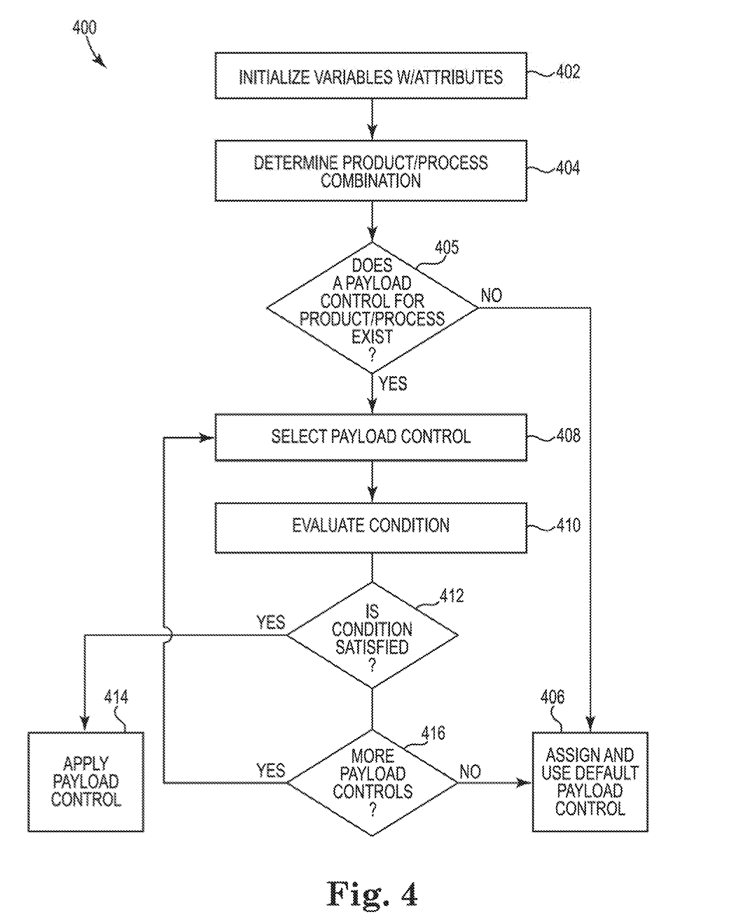

FIG. 4 illustrates an example evaluation process 400. The example evaluation process 400 can be applied for all tasks, and each task can have multiple corresponding payload controls as different paths in a decision tree. In the example, the variables to be used in the controls are initialized with the relevant attributes at 402. In one example, this can include using the “SET” directive of SQL to bring outside variables into the query. For example, this statement sets the “copy” variable to be used later:

SET @copy=15;

The relevant controls for a given process/product combination for a given task are determined at 404. In one example, the relevant processes can be searched via an SQL query, such as:

SELECT*FROM exps WHERE process=[process] AND product=[product]

where “exps” is the name given to set of payload expressions in the database and where “process” and “product” are supplied at the time of the query.

If the query does riot develop any payload controls at 405, a default payload control is assigned and used at 406, as described above. If, however, the query does develop a set of at least one payload control at 405, a payload control is selected from the set of at least one payload control at 408, such as by running a query such as:

PREPARE stmt1 FROM [str]

where “stmt1” is the selected payload control and “str” is an SQL statement and may possibly contain “@” variables defined using the SQL “set” directive.

The outcome of this query is the payload estimate for the task. In this example, SQL queries are not written for individual tasks. With this example feature, the variability is removed from a common SQL statement and put it on when it is applicable. A determination is made as to whether a condition of the learned payload control is met at 410. For example, the guard of the selected payload control is evaluated at 410, and if the condition is satisfies at 412, such as if a Boolean of the guard is true, the payload control is applied, such as the computation is performed, and the payload estimate is determined at 414. The result of the prepared statement “result” can be determined as:

EXECUTE SELECT result

If the guard condition, in the example, is not satisfied at 412, another payload control is selected at 416 from the set of at least one payload controls at 408 and evaluated if one exists. If the set of at least one payload controls is empty and all payload expressions have unsatisfied guard conditions at 416, a default payload control is assigned and used at 406.

A cross-cutting aspect of using SQL to evaluate a payload control is that we get terminals and non-terminals without having to know the referred to mathematical library. This provides a consistency through a common platform or vocabulary for the diverse sites and applications of an enterprise. Also, an SQL engine provides a uniform mechanism, such as a single query, to compute a multiplicity of controls with and without capability attributes. Depending on the control, relevant attributes are determined dynamically such as at query time. For example, if a payload control for a cutter is “max (sizel, sizew),” where sizel, sizew are attributes taken from a customers order, then no capability attribute are accessed. If, however, the control was “max (sizel, sizew)/cap_cutter”, the SQL query would receive the capability attribute.

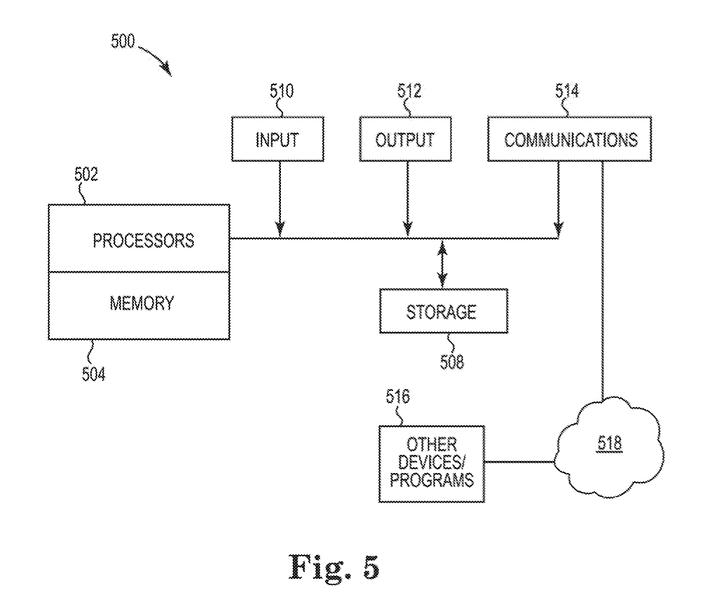

FIG. 5 illustrates an example computer system that can be employed in an operating environment and used to host or run a computer application included on one or more computer readable storage mediums storing computer executable instructions for controlling the computer system, such as a computing device, to perform a process. In one example, the computer system of FIG. 5 can be used to implement the process to determine a payload estimates, such as process 200, and its associated processes 300 and 400,

The exemplary computer system of FIG. 5 includes a computing device, such as computing device 500. Computing device 500 typically includes one or more processors 502 and memory 504. The processors 502 may include two or more processing cores on a chip or two or more processor chips. In some examples, the computing device 500 can also have one or more additional processing or specialized processors (not shown), such as a graphics processor for general-purpose computing on graphics processor units, to perform processing functions offloaded from the processor 502. Memory 504 may be arranged in a hierarchy and may include one or more levels of cache. Memory 504 may be volatile (such as random access memory (RAM)), non-volatile (such as read only memory (ROM), flash memory, etc.), or some combination of the two. The computing device 500 can take one or more of several forms. Such forms include a tablet, a personal computer, a workstation, a server, a handheld device, a consumer electronic device such as a video game console or a digital video recorder), or other, and can be a stand-alone device or configured as part of a computer network, computer cluster, cloud services infrastructure, or other.

Computing device 500 may also include additional storage 508. Storage 508 may be removable and/or non-removable and can include magnetic or optical disks or solid-state memory, or flash storage devices. Computer storage media includes volatile and nonvolatile, removable and non-removable media implemented in any suitable method or technology for storage of information such as computer readable instructions, data structures, program modules or other data. A propagating signal by itself does not qualify as storage media.

Computing device 500 often includes one or more input and/or output connections, such as USB connections, display ports, proprietary connections, and others to connect to various devices to receive and/or provide inputs and outputs. Input devices 510 may include devices such as keyboard, pointing device (e.g., mouse), pen, voice input device, touch input device, or other. Output devices 512 may include devices such as a display, speakers, printer, or the like. Computing device 500 often includes one or more communication connections 514 that allow computing device 500 to communicate with other computers/applications 516. Example communication connections can include, but are not limited to, an Ethernet interface, a wireless interface, a bus interface, storage area network interface, a proprietary interface. The communication connections can be used to couple the computing device 500 to a computer network 518, which is a collection of computing devices and possibly other devices interconnected by communications channels that facilitate communications and allows sharing of resources and information among interconnected devices. Examples of computer networks include a local are network, a wide area network, the Internet, or other network.

Computing device 500 can be configured to run an operating system software program and one or more computer applications, which make up a system platform. A computer application configured to execute on the computing device 500 is typically provided as set of instructions written in a programming language. A computer application configured to execute on the computing device 500 includes at least one computing process (or computing task), which is an executing program. Each computing process provides the computing resources to execute the program.

Learning payload controls for a product-specific process are independent activities, and thus can be performed in parallel. Learning can be done quickly using, for example, a distributed computing system including computer clusters or a large-scale data processing system such as Hadoop available under an Apache license, of which the computing device 500 can be a part.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A method of determining a payload estimate for a task in a process, comprising:
applying machine learning to process information to determine a learned payload control corresponding to the task in the process;
storing the learned payload control in a database; and
evaluating the payload estimate, including
searching the database for a plurality of payload controls relevant to the task including the learned payload control;
determining whether a condition of the learned payload control s met; and
applying the payload control to determine the payload estimate using process information if the condition of the learned payload control is satisfied.

2. The method of claim 1 wherein the condition of the learned payload control is a Boolean expression satisfied when true.

3. The method of claim 1 wherein learning the payload control includes learning from a default payload control.

4. The method of claim 3 wherein the default payload control is applied if the condition is not satisfied.

5. The method of claim 3 wherein the default payload control is applied if there is insufficient process information for learning the payload control.

6. The method of claim 1 wherein the machine learning includes an evolutionary process.

7. The method of claim 6 wherein computing the payload estimate includes evaluating the fitness of the payload control.

8. The method of claim 7 wherein the payload control is translated from a chromosome.

9. A computer readable medium for storing computer executable instructions for controlling a computing device to perform a method of determining a payload estimate for a task in a process, the method comprising:
applying machine learning to process information to determine a learned payload control corresponding to the task in the process;
storing a learned payload control in a database; and
evaluating the payload estimate, including
searching the database for a plurality of payload controls relevant to the task including the learned payload control;
determining whether a condition of the learned payload control is met; and
applying the compute control to determine the payload estimate using process information if the condition of the learned payload control is satisfied.

10. The computer readable medium of claim 9 wherein process information provided from a management information services or enterprise resource planning tool.

11. The computer readable medium of claim 9 wherein the machine learning is an artificial intelligence including genetic expression programming.

12. The computer readable medium of claim 11 wherein payload controls are learned as individual genes of a chromosome.

13. The computer readable medium of claim 9 wherein the storing includes indexing the learned controls for retrieval.

14. A system for determining a payload estimate for a task in a process, comprising:
applying machine learning to process information to determine a learned payload control corresponding to the task in the process;
storing the learned payload control in a database; and
evaluating the payload estimate with a processor, including
searching the database for a plurality of payload controls relevant to the task including the learned payload control;
determining whether a condition of the learned payload control is met; and
applying the payload control to determine the payload using process information if the condition of the learned payload control is satisfied.

15. The system of claim 14 including a computing device for the processing.
